(19) United States
(12) Patent Application Publication
(10) Pub. No.: US 2008/0081608 A1
(43) Pub. Date: Apr. 3, 2008

(54) Near Field Communication Enabled Diagnostic Device

(75) Inventors: Nadi Sakir Findikli, Cary, NC (US); Leland Scott Bloebaum, Cary, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB, Lund (SE)

(21) Appl. No.: 11/537,068

(22) Filed: Sep. 29, 2006

(51) Int. Cl. H04Q 7/20

(52) U.S. Cl. 455/425

(57) ABSTRACT

A portable consumer electronic device includes a Near Field Communication (NFC) interface, and a controller. The controller collects and stores diagnostic data associated with a communication function of the portable consumer electronic device in memory. When the NFC interface establishes an NFC link with an external NFC-capable device, the NFC interface transmits user data to effect a protected function associated with the NFC-capable device. The controller also causes the NFC interface to transmit the stored diagnostic data over the NFC link to the NFC-capable device.

### BACKGROUND

The present invention relates generally to consumer electronic devices, and particularly to Near Field Communication (NFC) capable portable communication devices.

Some consumer electronic devices are configured to collect and store diagnostics data. For example, some cellular telephone manufacturers pre-configure their products to collect metrics regarding the number of dropped calls, data throughput, and other network parameters. The cellular telephones then store this information for later retrieval by the manufacturer.

Conventional methods of extracting these metrics typically fall into two categories. The first category includes event-driven methods in which the cellular telephone transmits an error message upon experiencing a predetermined event, such as a dropped call or a software error. Event driven methods occur without the user's knowledge, and thus, do not inconvenience the user. However, these methods are usually limited to sending only small amounts of high-level data, which may not be helpful to a technician troubleshooting the problem.

The second category includes methods that facilitate the extraction of more detailed information from the cellular telephone. These methods usually require the user to periodically download the collected information from memory. Such methods may inconvenience the user by requiring that he or she physically connect the cellular telephone to some manufacturer/service provider hardware. Moreover, there is a limited amount of memory in the cellular telephones. Thus, there is a strong likelihood that some or all of the collected diagnostics data is overwritten before it can be downloaded to the manufacturer.

### SUMMARY

The present invention comprises a Near Field Communication (NFC) capable portable communication device that periodically downloads detailed diagnostic data to a service provider or manufacturer, for example, while minimizing inconvenience to the user. The user may employ the NFC-capable portable communication device to communicate with remote parties via a wireless communication network, and as a keycard to gain access to a restricted area or to purchase items from a merchant in a Point-of-Sale (PoS) system.

In one embodiment, an NFC-capable portable communication device comprises an NFC interface and a controller. The controller collects and stores diagnostics data in a memory of the device that reflects the operation of the communication functions. Periodically, the user employs the device as a keycard or as a PoS device, for example, and brings the device with close physical proximity of an external NFC device to establish an NFC link. Upon establishing the NFC link, the NFC interface transmits user data to gain access to a restricted area or purchase an item from a merchant. The NFC interface also receives instructions and an identity of the external NFC device over the NFC link. The controller determines whether the external NFC device can receive diagnostics data based on the received identity and, if so, transmits the collected diagnostics data from its memory to the external NFC device.

In another embodiment, the user travels with his device to a location having an external NFC device specially designated as a diagnostic data collector. The user establishes an NFC link by bringing the device into close physical proximity with the specially designated NFC device. Once the NFC link is established, the user's device receives instructions and an identity of the NFC device. Based on the identity and the instructions, the controller in the user's device causes the NFC interface to transmit the collected diagnostics data from its memory to the NFC device.

### BRIEF DESCRIPTION OF THE DRAWINGS

FIG. 1 is a block diagram that illustrates a portable communication device configured according to one embodiment of the present invention.

FIG. 2 is a perspective view of a portable communication device configured according to one embodiment of the present invention.

FIG. 3 is a block diagram illustrating a communication system suitable for use with a portable communication device configured according to one embodiment of the present invention.

FIG. 4 is a perspective view of an NFC-capable device that receives diagnostics data from a portable communication device according to one embodiment of the present invention.

FIG. 5 is a flow diagram illustrating a method by which the portable communication device may download diagnostics data to the apparatus of FIG. 4 according to one embodiment of the present invention.

FIG. 6 is a listing of some exemplary parameters associated with the collected diagnostics data.

FIG. 7 is a perspective view of another NFC-capable device that receives diagnostics data from a portable communication device according to one embodiment of the present invention.

FIG. 8 is a flow diagram illustrating a method by which the portable communication device may download diagnostics data to the apparatus of FIG. 7 according to one embodiment of the present invention.

FIG. 9 is a flow diagram illustrating a method of uploading information to a portable communication device according to one embodiment of the present invention.

### DETAILED DESCRIPTION

The present invention relates to a dual-function, NFC-capable portable communication device. The user may employ the NFC-capable portable communication device to communicate voice and/or data with one or more remote parties via a wireless communication network. The user may also use the device as a “smartcard” or “keycard” to gain entry to a building or unlock door, or as a Point-of-Sale (PoS) device to purchase items from a merchant, for example. Typically, such dual-function NFC-capable devices transfer user data, such as financial data and proof of identity or authorization, to an external NFC device when the two devices are placed in close physical proximity with each other. In addition to transferring this user data, however, the present invention configures the dual-function devices to also transfer detailed diagnostic data to a remote server via the external NFC device, and to receive data and instructions from a remote server via the external NFC device. The diagnostic data may comprise information related to the communications functions of the device that service providers and/or manufacturers can use, for example, to troubleshoot problems and establish a baseline operation for the device.

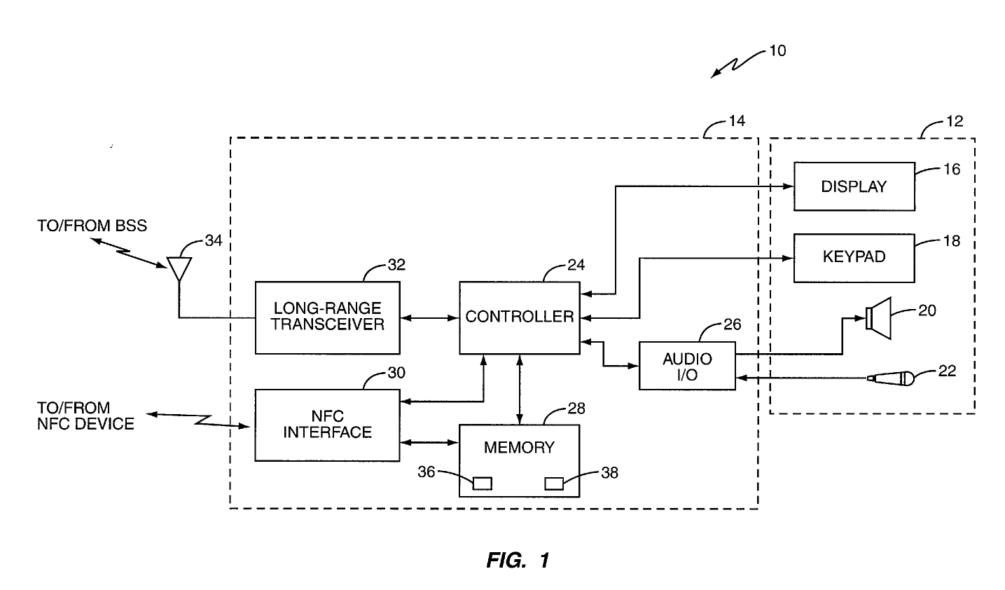

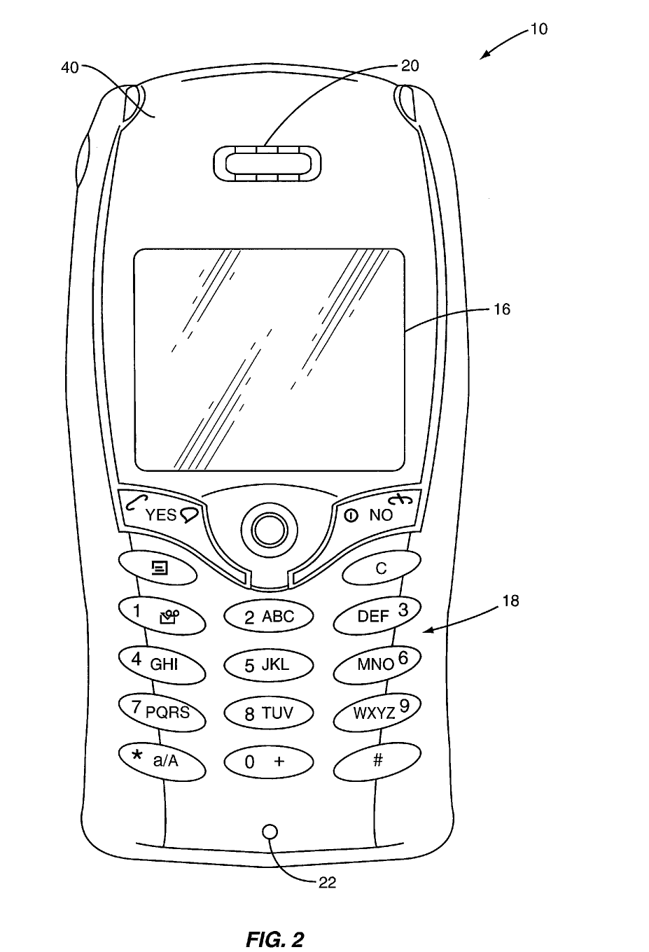

FIGS. 1 and 2 illustrate a portable wireless communication device 10 suitable for use with the present invention. In the specification and figures, the portable wireless communication device 10 is specifically embodied as a cellular telephone; however, this is for illustrative purposes only. Those skilled in the art should appreciate that the present invention may be embodied in other types of portable consumer electronics devices including, but not limited to, a Personal Digital Assistant (PDA), a palmtop or laptop computer, a satellite phone, or other type of portable or hand-held electronic device.

Portable wireless communication device 10 comprises a user interface (UI) 12 and a communication circuit 14 disposed within a housing 40. UI 12 includes a display 16, a keypad 18, a speaker 20, and a microphone 22. Communication circuit 14 comprises a controller 24, an audio I/O circuit 26, memory 28, and a long-range transceiver circuit 32 connected to an antenna 34. The operation of the UI 12 and the communication circuit 14 with respect to communicating with a remote party is well known in the art. Therefore, this functionality is not described in detail herein. It is sufficient for the purposes of the present invention to understand that the device 10 is a fully functional cellular radio device capable of operating according to any known standard. Such standards include, but are not limited to, Global System for Mobile Communications (GSM), Universal Mobile Telecommunication System (UMTS), TIA/EIA-136, Code Division Multiple Access (CDMA), cdmaOne, cdma2000, and Wideband CDMA.

In addition to the components that facilitate long-range communications, device 10 also comprises a Near Field Communication (NFC) interface 30. Near Field Communication is a short-range wireless connectivity technology that uses magnetic field induction to permit devices to share information with each other. Usually, NFC devices operate at a frequency of 13.56 MHz and may transfer data at rates up to 424 Kbs; however, data transfer rates of up to 2 Mbps and above may soon be possible. Communication between two NFC-capable devices occurs when they are brought into contact with each other, or within close physical proximity of one another. The distance separating two NFC-capable devices can be anywhere between about 0 and 4 centimeters; however, the distance can be up to about 20 centimeters.

Near Field Communication technology is known in the art, therefore, only a brief description of this technology appears here for context. However, interested readers can learn more about NFC technology by reading any of the specifications available from the NFC Forum (http://www.nfc-forum.org). Currently, there are four specification documents available standardizing this technology. These are, the “NFC Data Exchange Format (NDEF) Technical Specification,” the “NFC Record Type Definition (RTD) Technical Specification,” the “NFC Text RTD Technical Specification,” and the “NFC URI RTD Technical Specification.” Each of these documents was released as version 1.0 on Jul. 24, 2006.

The NFC interface 30 may comprise, for example, a “tag” or chip, and may or may not include its own internal power supply. NFC interface 30 may also draw power from a battery (not shown) of device 10. Those NFC interfaces 30 having their own power supply draw power are termed “active” devices, while those NFC interfaces 30 that do not include their own power supply are termed “passive” devices. Passive NFC interfaces utilize a magnetic field radiated by an “active” NFC device, such as an NFC reader, for power. Once the device 10 is close enough to the NFC device, the energy from the magnetic field powers the NFC interface 30 so that it can establish the NFC link and communicate data.

In one embodiment, NFC interface 30 comprises an “active” transceiver circuit capable of communicating data to/from a corresponding NFC-capable device. To conserve power, the NFC interface 30 may operate in a “tag emulation” mode. In this mode, the NFC interface 30 “sleeps” until it detects magnetic energy from an external NFC device. Detecting the magnetic energy triggers the NFC interface 30 to “wake up.” The NFC interface 30 may then operate like a programmable tag to communicate data to/from the external NFC device.

In other embodiments, the NFC interface 30 comprises an active device such that it powers other passive NFC devices. In these embodiments, the magnetic field generated by the NFC interface 30 activates other “passive” NFC devices or NFC devices operating in a tag emulation mode. In still other embodiments, the NFC interface 30 is an active device that operates in a “peer” mode with other external NCF devices. In the peer mode, both the NFC interface 30 and the external NFC device may be active devices. Once the two devices are placed within close physical proximity of each other, the data exchange between the two devices is bi-directional.

As previously stated, device 10 may be configured to collect and store diagnostics data for download to another NFC-capable device. Therefore, an application program 36 that monitors the communication functions of device may be stored in memory 28. Controller 24 may execute instructions according to the application program 36 to collect diagnostics data over time or responsive to a predetermined event. For example, controller 24 may increment a counter whenever the device 10 experiences a dropped call. Controller 24 may store the collected diagnostics data 38 in memory 26 for later retrieval and download via the NFC interface 30, as described in more detail later.

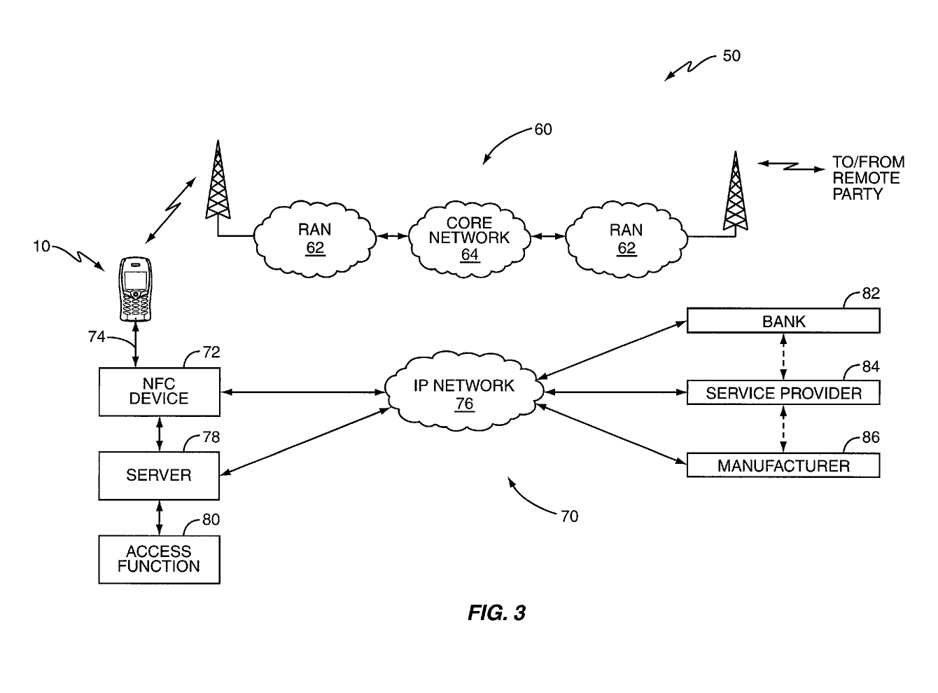

FIG. 3 is a block diagram that illustrates an exemplary system 50 in which device 10 may operate. System 50 comprises a wireless communications network 60 and an NFC data collection network 70. Wireless communications network 60 comprises one or more Radio Access Networks (RAN) 62 and a Core Network (CN) 64. The operation of the wireless communications network 50 is well-known in the art, and therefore, not described in detail here. It is sufficient to understand that the wireless communications network 50 allows a user of device 10 to communicate voice and/or data traffic with one or more remote parties.

NFC network 70 comprises an NFC reader 72 that connects to an IP network 76 such as the Internet, and a server 78. “Swiping” or contacting the NFC reader 72 with device 10 establishes an NFC link 74 as previously described. In embodiments where the user employs device 10 as a keycard, the NFC reader 72 receives ID codes or other user data from the device 10 and transfers that data to the server 78. The NFC reader may transmit the data to the server 78 via a local connection or the IP network 76. The server 78 may validate the received data and, if valid, generates a control signal to an access function 80. The access function 80 may, for example, unlock a door for the user or allow the user entry through a turnstile.

In other embodiments, the NFC reader 72 may send the received user data to one or more external servers via the IP network 76. For example, where NFC reader 72 comprises part of a PoS system, the NFC reader 72 may receive a user account number, credit card number, a merchant identifier, and the desired amount of the transaction over the NFC link 74. The NFC reader 72 sends this data to a server 82 associated with a bank or other financial institution. Depending upon the validity of this data and/or the availability of user funds, the bank server 82 will return a message to the NFC reader 72 either denying or confirming the requested transaction.

According to the present invention, device 10 is also configured to “passively” transfer all or portions of the diagnostics data stored in memory 28 whenever the user employs the device 10 to unlock a door or purchase an item, for example. That is, no explicit user interaction is required to download the diagnostic data other than bring the device 10 into close physical proximity of the NFC reader 72. This permits a service provider or manufacturer to periodically collect diagnostics data collected by device 10 with minimal inconvenience to the user.

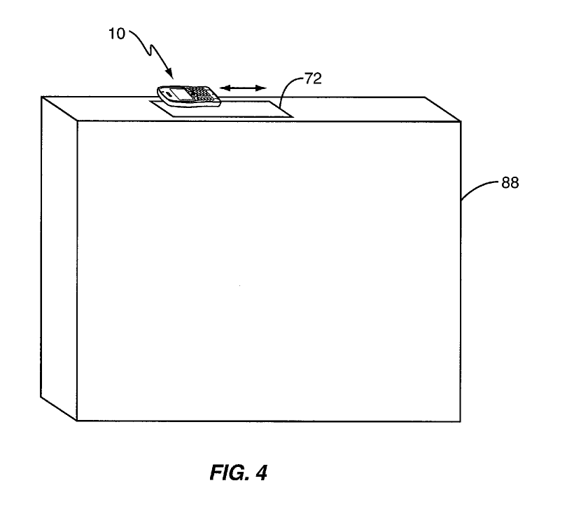

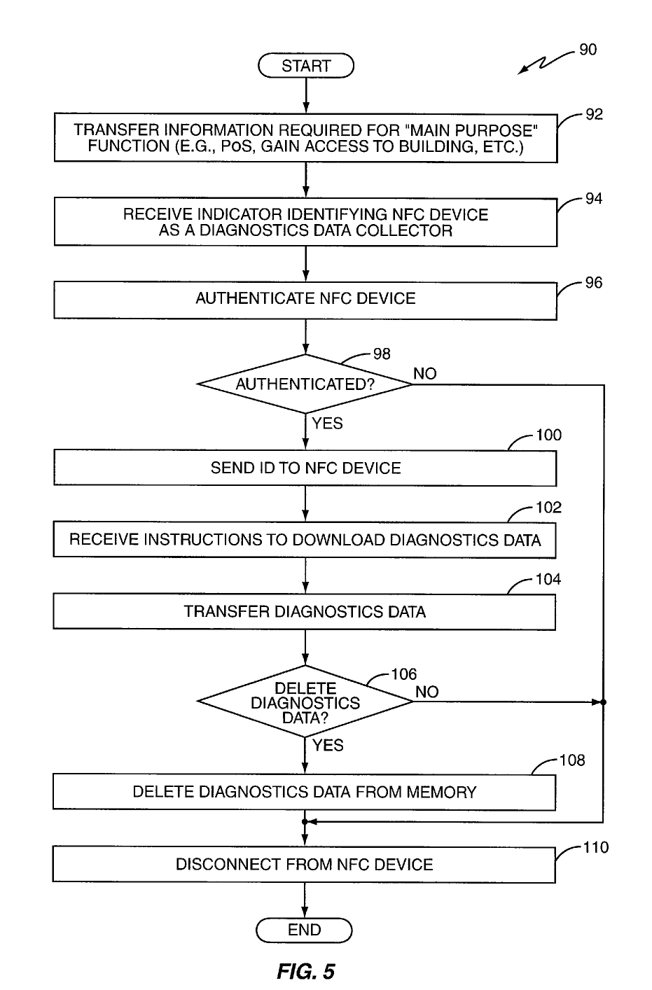

FIGS. 4-5 illustrate one embodiment wherein device 10 passively transfers all or a portion of the diagnostic data without the user's knowledge. In this embodiment, the user employs device 10 as a “keycard” to gain entry to a restricted area. The restricted area may have a turnstile or gate 88 having NFC reader 72 disposed on or near a top surface. To establish an NFC link 74 and gain access to the restricted area, the user merely swipes the device 10 over, or contacts device 10 to, the NFC reader 72. Establishing the NFC link may include performing a link-level authentication process between device 10 and the NFC reader 72.

As seen in method 90 of FIG. 5, once the NFC link 74 is established, the NFC interface 30 in device 10 transfers the necessary user data to a remote server 78 via the NFC device 72 so that the user may gain access to the restricted area (box 92). The NFC interface 30 also receives an identifier from NFC reader 72 that identifies it as a diagnostics collector device (box 94). The received identifier indicates to device 10 whether the NFC reader 72 will receive diagnostics data for a remote server 78, 82, 84, 86, and/or establish a secure communications link with one of the servers to facilitate the transfer received diagnostic data to one or more of the servers. The identifier may be, for example, a predetermined alpha-numeric code known a priori to the device 10. Controller 24 may check the received identifier and, if valid, generate a control signal to the NFC interface 30 to cause it to authenticate the server(s) via the NFC device 72 (box 96).

In one embodiment, the authentication process comprises a bi-directional challenge/response process by which the device 10 and a remote server authenticate each other. Particularly, the device 10 sends a challenge to a remote server via the NFC device 72. The server may then respond to the challenge via the NFC device 72 with a valid authentication code, and may include a challenge of its own with the response. If the device 10 determines that the received response is an invalid authentication code (box 98), the device 10 may disconnect from the NFC device 72 (box 110). Otherwise, the controller 24 may cause the NFC interface 30 to send an ID of device 10 to the server in response to the challenge sent by the server (box 100). The ID sent by device 10 may be any indicator or identifier known in the art such the telephone number of the device 10. The server would check the response and, if valid, return instructions to device 10 via the NFC reader 72 for downloading the diagnostics data stored in memory 28 to the NFC reader 72 (box 102).

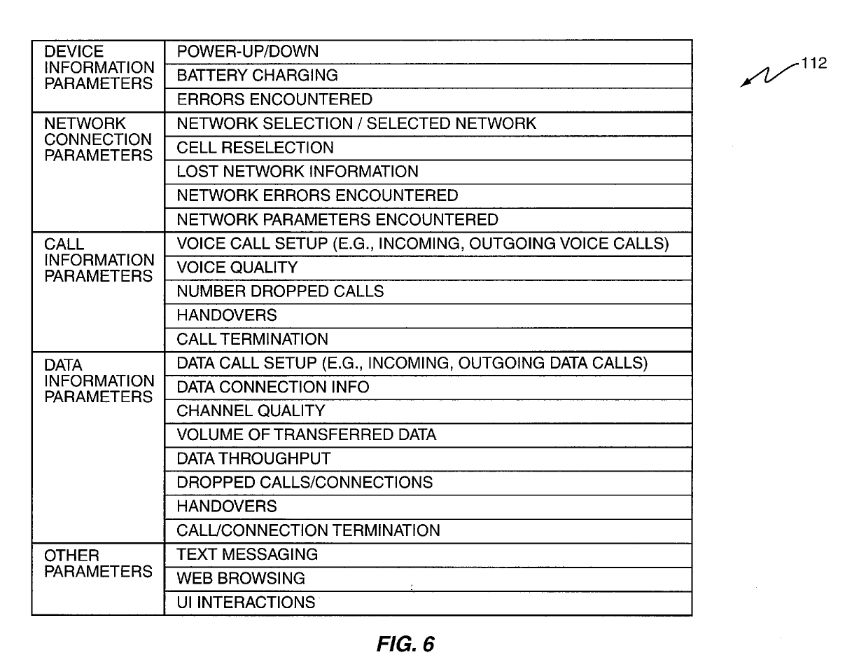

The instructions sent by the NFC reader 72 may comprise a command having one or more parameters that causes controller to access and download all or selected portions of the stored diagnostics data to the NFC reader 72. For example, FIG. 6 illustrates a table 112 that lists some exemplary communications parameter identifiers that controller 24 may monitor and collect diagnostics information for. Those skilled in the art will readily appreciate that this table in not exhaustive, and that the controller 24 may collect diagnostics data on other parameters not specifically listed here. The command parameters may specify that device 10 should download only the diagnostics data associated with voice quality, channel quality, and dropped calls. Controller 24 could therefore retrieve and transfer only the diagnostics data specified by those parameters (box 104). The NFC reader 72 could then transfer this data to an appropriate one of the servers 84, 86.

At some point, the NFC interface 30 may receive a command from NFC reader 72 to delete the diagnostics data from memory 28 (box 106). This may occur, for example, during the diagnostics data transfer (e.g., when a user removes the device 10 from within the proximity of NFC reader 72), or after the device 10 has completed transferring the diagnostics data to NFC reader 72. The command may identify which portions of the data were successfully received. The controller 24 could delete those identified portions of the diagnostics data and maintain the remaining portions in memory 28 to be downloaded later (box 108). Then, the NFC interface 30 may disconnect from the NFC reader 72.

It should be noted that the present invention is not limited to the authentication process previously described. Rather, the present invention may employ any authentication process known in the art. In addition, some embodiments of the present invention do not require direct authentication between the device 10 and the server prior to transferring diagnostics data. In one embodiment, for example, the NFC reader 72 includes sufficient logic and resources to perform the authentication process without connecting to a remote server. In these cases, the NFC reader 72 could, upon successful authentication, communicate data to/from device 10. Later, the NFC reader 72 could transfer the diagnostics data to an appropriate server, which may or may not include another authentication process between the NFC reader 72 and the server.

In other embodiments not requiring user interaction, the user may employ device 10 to conduct a transaction with an NFC-enabled PoS system. In these cases, the device 10 would transfer user data relating to an intended purchase or transaction to NFC reader 72. For example, the NFC reader 72 may transfer data to the device 10 relating to the transaction and possible settlement options. Device 10 could then reply with data identifying a particular settlement option (e.g., pay with a credit card, debit card, e-coupon, etc.). The NFC reader 72 would then communicate this user data to a server 82 for processing the settlement of the transaction. The NFC reader 72 could also receive the diagnostics data from device 10, and forward it to one or more of the servers 82, 84, 86 as previously described.

In addition to these passive downloads, the present invention also contemplates an embodiment wherein the NFC reader 72 comprises a dedicated diagnostics data collector. The service provider's and/or the manufacturer's servers 84, 86, could connect to such dedicated NFC devices 72 via the Internet or other IP network. In these cases, the service providers and/or the manufacturers could collect and store the downloaded diagnostics data directly, and analyze the data as needed or desired.

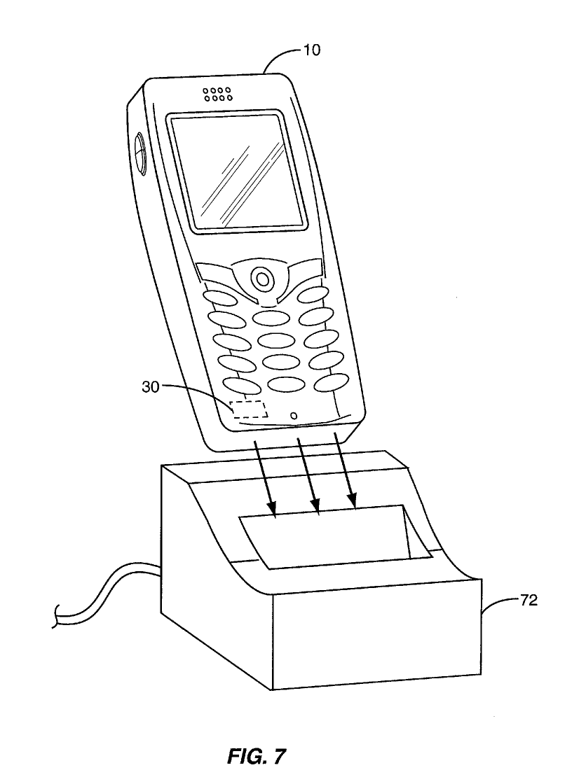

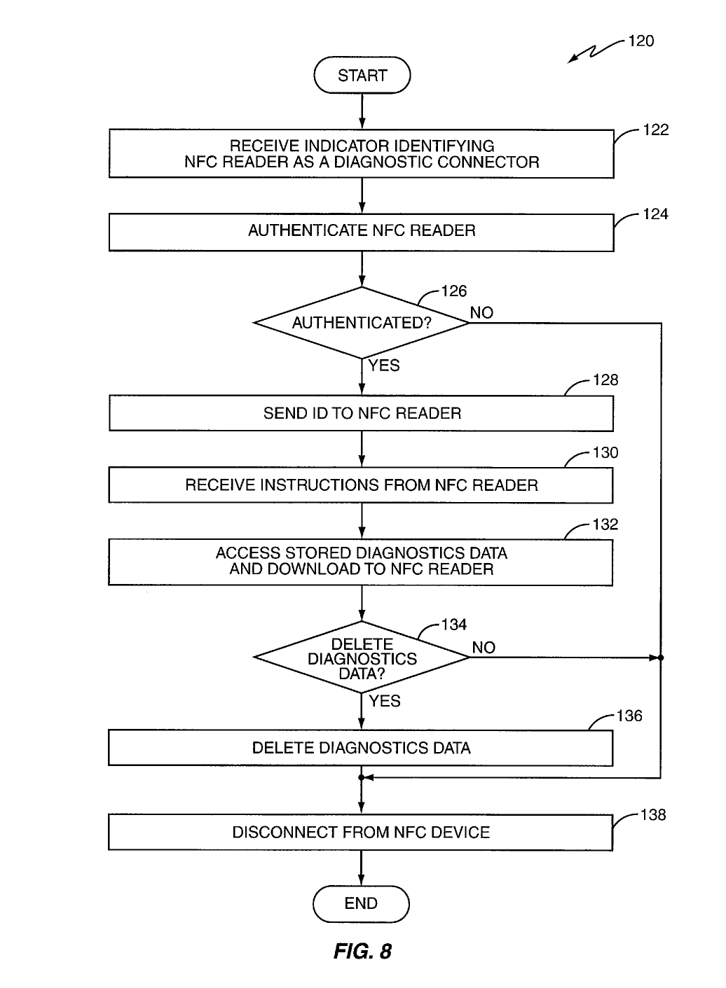

FIGS. 7-8, for example, illustrate an exemplary dedicated NFC reader 72 formed as a cradle that receives device 10. Other embodiments, however, may utilize a substantially flat NFC-capable pad as a dedicated NFC reader 72 upon which the user lays device 10. The NFC reader 72 may be located, for example, at a centralized location to where the user may travel with device 10. Additionally, the NFC reader 72 may be portable so that authorized personnel can carry the NFC reader 72 to the user. To establish the NFC link 74, the user simply inserts the device 10 into the NFC reader 72.

Method 120 of FIG. 8 assumes that the user has inserted device 10 into the NFC reader 72 to establish the NFC link 74, and that a link-level authentication between device 10 and NFC reader 72 has been successfully performed. As previously described, the device 10 may receive an identifier that indicates the NFC device 72 as being a dedicated diagnostics collector (box 122). If the identifier is valid, the device 10 authenticates an appropriate remote server 84, 86 via the NFC reader 72 (box 124). A successful authentication (box 126) may cause the device 10 to transmit its own unique identifier, such as its telephone number, to server 84, 86 via the NFC reader 72 (box 128). The device 10 may then receive instructions from the NFC reader 72, which may include one or more of the aforementioned parameters (box 130). The device 10 may then transfer the selected diagnostics data, and delete the diagnostics data from memory 28 (box 132, 134, 136). The device 10 then disconnects from the dedicated NFC device 72 (box 138).

As in the previous embodiments, using NFC reader 72 to transfer the authentication information between device 10 and remote server 84, 86 is not required. In other embodiments, NFC reader 72 may perform the authentication process without the server 84, 86.

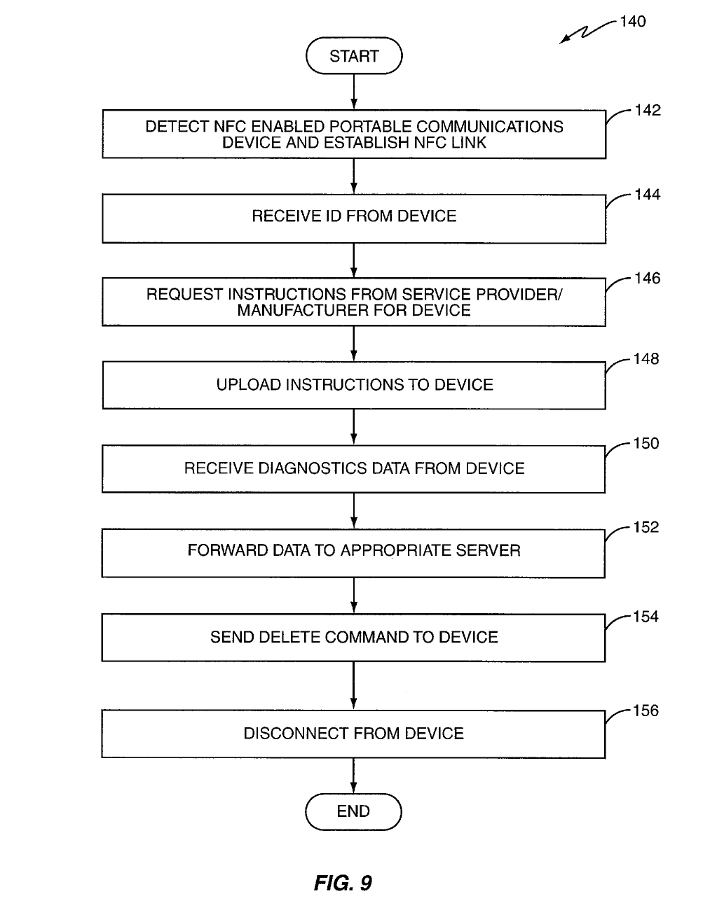

As can be seen from the above embodiments, the present invention allows service providers, manufacturers, or other entities granular control over the diagnostics collection abilities of device 10. Further, the present invention allows these entities to exert this control over many devices 10 generally, or over one or more specifically identified devices 10. FIG. 9, for example, illustrates a method 140 by which the service provider and/or manufacturer can control a specific device 10 using the ID of the device 10.

Method 140 begins when the NFC reader 72 detects the presence of device 10 and establishes the NFC link (box 142). After receiving the unique identifier of the device 10 over the NFC link 74 (box 144), the NFC reader 72 may request instructions from the appropriate server 84, 86 (box 146). The NFC device 72 could include the received unique identifier in the instruction request such that the appropriate server 84, 86 return instructions and/or parameters specifically intended for that device 10. As stated above, the requested instructions may include commands or parameters for specific diagnostic information from device 10. However, the instructions may also include other data that is to be uploaded to device 10 via NFC reader 72. Such data includes, but is not limited to, new application logic and new parameters for the controller 24 to monitor. The NFC device 72 may then upload the instructions and/or data to device 10 (box 148), and receive diagnostics data (box 150) as previously described. The NFC reader 72 then forwards the received diagnostics data to the appropriate server 84, 86 (box 152), and sends a delete command as previously described (box 154). The NFC reader 72 then disconnect from the device 10 (box 156).

This ability to upload instructions and other data to device 10 via the NFC reader 72 permits the service provider and/or manufacturer to remotely control some relatively complex aspects of the diagnostics collection abilities of targeted devices 10 while minimizing user interaction. For example, uploading new application logic may facilitate control over how and when the device 10 monitors and collects diagnostic data. Likewise, new parameters may be sent so that the controller 24 can monitor aspects of the communications functions not typically monitored by device 10. For example, service providers and/or manufacturers may detect a pattern of errors by analyzing the downloaded diagnostics data for one or more particular devices 10. In response, to this data, these entities may send new parameters for device 10 to monitor that comprise elements designed to provide a more detailed picture of the device 10 or its interaction with the wireless network.

In the previous embodiments, the NFC reader 72 is described as communicating with one or more of the servers 82, 84, 86 at substantially the same time as the device 10 is downloading diagnostic data. However, this may result in an unacceptable delay in some cases by requiring the user to leave the device 10 in close physical proximity with the NFC reader 72 for an extended time. Therefore, the NFC reader 72 may be configured to collect and temporarily store the diagnostics data received from the device 10. Later, at a predetermined time for example, the NFC reader 72 could connect to an appropriate server 82, 84, 86, and transfer the diagnostics data stored in its memory. Transferring the diagnostics data in this “off-line” manner could reduce the length of time that the user must maintain the NFC link 74 with the NFC reader 72.

Likewise, one or more of the servers 82, 84, 86 can upload the application logic, parameters, and/or instructions to one or more NFC readers 72 “off-line” (e.g., before the device 10 establishes an NFC link 74 with the NFC reader 72). For example, one or both of the servers 84, 86 may determine from historical information that a specific device 10 normally establishes an NFC link 74 with a specific NFC reader 72 at a typical time of day (e.g., the user may use device 10 at a particular NFC reader to enter his work building every morning at 8:00 a.m.). The servers 84, 86 could upload that particular NFC reader 72 with logic, parameters, and/or instructions specially designated for that device 10. The next time the user reports to work, the NFC reader 72 simply uploads the logic and/or instructions to device 10 without having to request instructions from the servers 84, 86. This reduces the need to exchange messages between the NFC reader 72 and the servers 84, 86 while the NFC link 74 is established thereby reducing the length of time the user must maintain the NFC link 74.

Additionally, the previous embodiments illustrate the service providers and/or manufacturers having a direct communications link to the NFC readers 72 via a public or private IP network. However, this direct communications link is not required. In other embodiments, such as those associated with PoS systems, the NFC reader 72 transfers the diagnostic data received from the user's device 10 to a third party server such as server 82 associated with the financial institution. In addition to confirming or denying the user's transaction, server 82 may temporarily store the diagnostic data received from device 10. Provided the service providers and manufacturers have an agreement with the financial institution, servers 84, 86 may retrieve this diagnostic data at predetermined times.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A portable consumer electronic device comprising:
memory configured to store diagnostic data collected by a portable consumer electronic device;
a short-range interface configured to establish a Near Field Communication (NFC) link with an external NFC device; and
a controller configured to control the short-range interface to transmit the diagnostic data to the external NFC device responsive to receiving a valid identifier from the NFC device over the NFC link.

2. The device of claim 1 further comprising a long-range transceiver configured to communicate wireless signals with a base station subsystem in a wireless communication network.

3. The device of claim 2 wherein the diagnostic data comprises information associated with communication functions of the portable consumer electronic device.

4. The device of claim 3 wherein the short-range interface is configured to transmit user data to the NFC device, the user data comprising information associated with an access function controlled by a server communicatively interfaced with the external NFC device.

5. The device of claim 3 wherein the short-range interface is configured to transmit user data to the NFC device, the user data comprising information associated with a user transaction.

6. The device of claim 1 wherein the controller is configured to transmit selected diagnostic data over the NFC link corresponding to one or more parameters received from the external NFC device.

7. The device of claim 1 wherein the controller is configured to collect the diagnostics data based on one or more parameters received over the NFC link from the external NFC device.

8. The device of claim 1 wherein the controller is configured to delete from the memory the portions of the diagnostic data received by the external NFC device.

9. A method of collecting diagnostic data stored in memory of a portable consumer electronic device, the method comprising:
establishing a Near Field Communication (NFC) link between the portable consumer electronic device and a corresponding external NFC device; and
transmitting diagnostic data stored in memory of the portable consumer electronic device to the external NFC device responsive to receiving a valid identifier from the NFC device over the NFC link.

10. The method of claim 9 further comprising establishing a long-range communications link to communicate wireless signals with a remote party via a base station subsystem.

11. The method of claim 9 further comprising receiving data from the NFC device over the NFC link.

12. The method of claim 11 wherein transmitting the diagnostic data comprises transmitting selected diagnostic data corresponding to one or more parameters received over the NFC link.

13. The method of claim 11 further comprising collecting selected diagnostic data corresponding to one or more parameters previously received over the NFC link, and storing the selected diagnostic data in the memory of the portable consumer electronic device.

14. The method of claim 9 wherein the identifier identifies the NFC device to the portable consumer electronic device.

15. The method of claim 14 further comprising authenticating the NFC device.

16. The method of claim 9 further comprising receiving application logic from the NFC device, and collecting the diagnostic data based on the application logic.

17. The method of claim 9 further comprising transmitting user data to the external NFC device responsive to establishing the NFC link.

18. The method of claim 17 wherein transmitting user data to the external NFC device comprises transmitting the user data to access a protected function associated with the NFC device.

19. The method of claim 17 wherein transmitting user data to the external NFC device comprises transmitting the user data to purchase an item.

20. The method of claim 9 further comprising deleting portions of the diagnostic data that were successfully received by the external NFC device from memory of the portable consumer electronic device.

21. A method of collecting diagnostic data stored in memory of a portable consumer electronic device, the method comprising:
establishing a Near Field Communication (NFC) link between a portable consumer electronic device and a corresponding external NFC device;
receiving diagnostic data from the portable consumer electronic device responsive to sending a valid identifier to the portable consumer electronic device over the NFC link.

22. The method of claim 21 further comprising transmitting data to the portable consumer electronic device based on an identifier received from the portable consumer electronic device.

23. The method of claim 22 wherein the data comprises one or more parameters that cause the portable consumer electronic device to transmit selected diagnostic data corresponding to the one or more parameters.

24. The method of claim 22 wherein the data comprises application logic that causes the portable consumer electronic device to collect the diagnostic data.

25. The method of claim 21 wherein the diagnostic data comprises information associated with one or more communication functions of the portable consumer electronic device.

26. The method of claim 21 further comprising receiving user data from the portable consumer electronic device responsive to establishing the NFC link.

27. The method of claim 26 further comprising transmitting the user data received from the portable electronic communication device to a first remote server for validation.

28. The method of claim 27 further comprising transmitting the diagnostic data received from the portable electronic communication device to a second remote server.

29. The method of claim 21 further comprising indicating to the portable consumer electronic device via the NFC link which portions of the diagnostic data were successfully received.
